(19) United States
(12) Patent Application Publication
(10) Pub. No.: US 2011/0255697 A1
(43) Pub. Date: Oct. 20, 2011

(54) DIGITAL SOUND PROJECTOR

(75) Inventors: LI QIAN, Beijing (CN); YU-QUAN WANG, Beijing (CN)

(73) Assignee: BEIJING FUNATE INNOVATION TECHNOLOGY CO., LTD., Beijing (CN)

(21) Appl. No.: 12/954,752

(22) Filed: Nov. 26, 2010

(30) Foreign Application Priority Data
Apr. 14, 2010 (CN) 201010146848.7

(51) Int. Cl. H04R 5/00

(52) U.S. Cl. 381/17

(57) ABSTRACT

The present disclosure provides a digital sound projector including an insulated panel, a number of acoustic cells and a signal processing device. The number of acoustic cells is located on a surface of the insulated panel and spaced apart from each other. Each one of the number of acoustic cells includes an acoustic element, a first electrode, and a second electrode. The first electrode and the second electrode are spaced apart from each other and electrically connected to the acoustic element. The signal processing device provides a number of delayed electrical signals to the acoustic element. Each one of the acoustic elements includes a carbon nanotube film structure.

### CROSS-REFERENCE TO RELATED APPLICATIONS

This application claims all benefits accruing under 35 U.S.C. §119 from China Patent Application No. 201010146848.7, filed on Apr. 14, 2010, in the China Intellectual Property Office, the contents of which are hereby incorporated by reference. This application is related to application entitled, “DIGITAL SOUND PROJECTOR”, filed **** (Atty. Docket No. US29402).

### BACKGROUND

1. Technical Field

The present disclosure relates to a digital sound projector.

2. Description of Related Art

Nowadays, digital sound projectors attract a deal of great attention because the digital sound projector can produce surround sound without complex wiring. The digital sound projector includes an insulated panel and a number of speakers arranged on a surface of the insulated panel in an array. The digital sound projector delays the time and changes the direction of the sounds of the speakers. Therefore, the delayed sounds of the speakers are focused in at least two directions to form at least two sound beams. In the WO0123104A1, a method how to direct sound has been described detailed, and the teachings of which are incorporated by reference. Each of the sound beams spreads along a predetermined direction and then may be reflected by the wall of a room. The sound beams form a sound source surrounding the listener with an array of speakers of the digital sound projector.

However, an operation principle of the speakers used in the above-described digital sound projector is electro-mechanical-acoustic. A structure of the electro-mechanical-acoustic speaker is complex so that the weight of the digital sound projector is difficult to make light and the thickness is difficult to make thin.

What is needed, therefore, is a digital sound projector with a simple structure, thinner and lighter.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a front view of one embodiment of an inner structure of a digital sound projector.

FIG. 2 is a top view of the inner structure of the digital sound projector of FIG. 1.

FIG. 3 is a schematic view of one embodiment of a structure of an insulated panel and acoustic cells.

FIG. 4 is a schematic structural view of another embodiment of a structure of an insulated panel and acoustic cells.

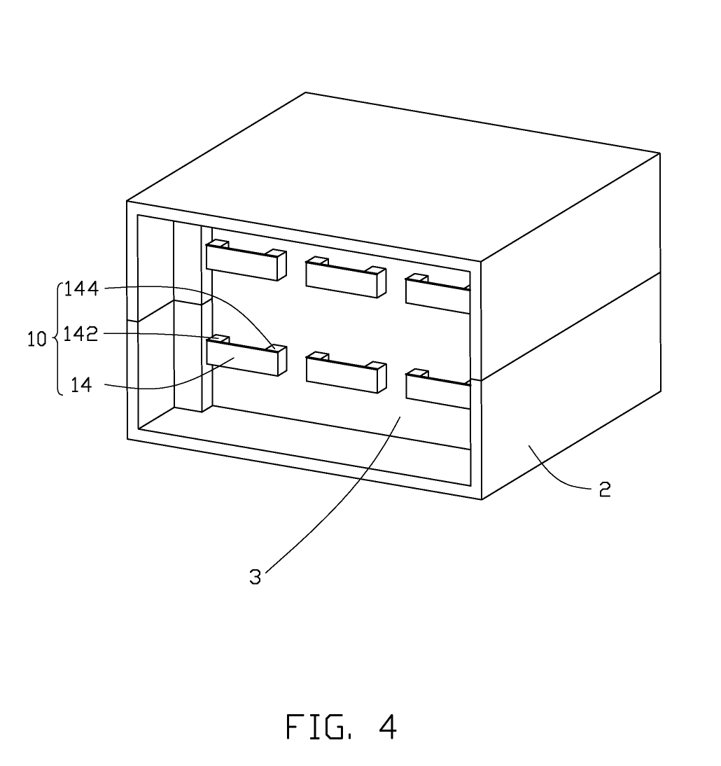

FIG. 5 is a Scanning Electron Microscope (SEM) image of a drawn carbon nanotube film.

FIG. 6 is a schematic structural view of a carbon nanotube segment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

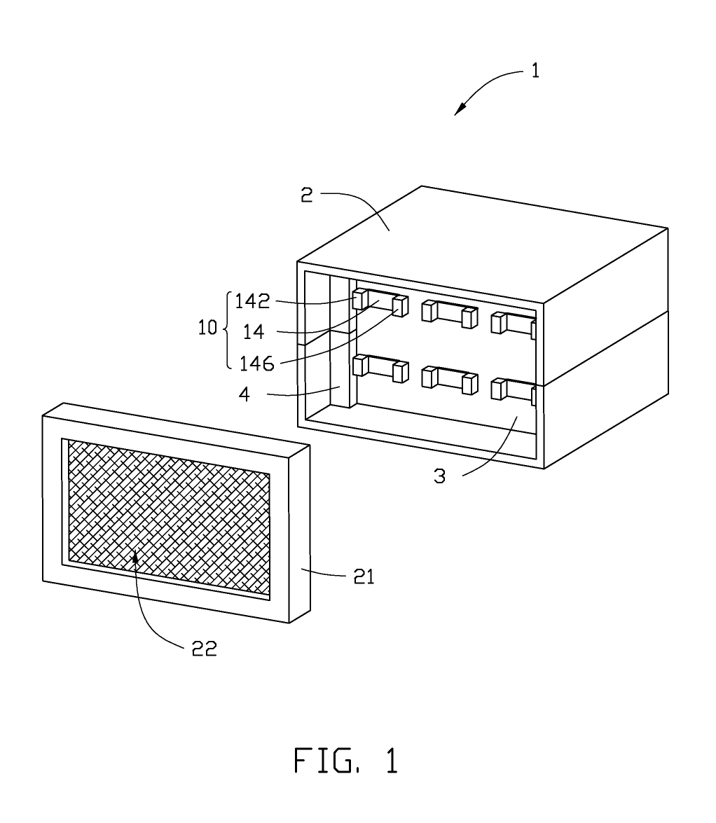

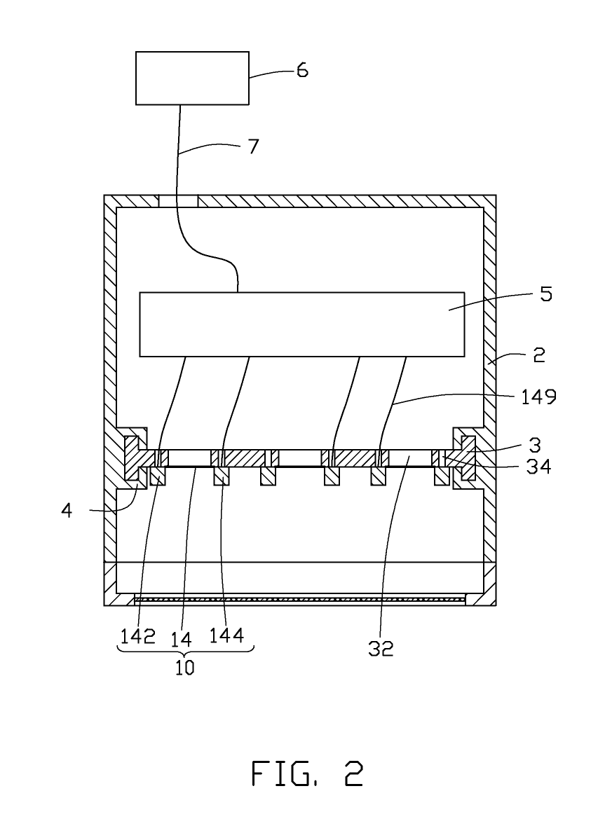

Referring to FIGS. 1, 2 and 3, a digital sound projector 1 of one embodiment is illustrated. The digital sound projector 1 includes a casing 2, an insulated panel 3, a number of acoustic cells 10 and a signal processing device 5. The insulated panel 3, the number of acoustic cells 10 and the signal processing device 5 are located in the casing 2. The signal processing device 5 is electrically connected to a signal source 6 through a first conducting wire 7. The signal source 6 can be located outside the casing 2.

The number of acoustic cells 10 can be uniformly arranged on a surface of the insulated panel 3. The number of acoustic cells 10 is located apart from each other and forms a one-dimensional array or a two-dimensional array. The number of acoustic cells 10 can be high-frequency acoustic cells, intermediate frequency acoustic cells, or low-frequency acoustic cells.

The shape of the casing 2 is not limited. The shape of the casing 2 can be cuboid, cubic, cylinder, or prism. In one embodiment, the shape of the casing 2 is cuboid. The casing 2 is hollow. The cuboid casing 2 has six walls. The wall of the cuboid casing 2, which is configured to face the listener is defined as a front wall. The front wall is removable. Another wall of the cuboid casing 2 opposite to the front wall is defined as a back wall. The other four walls except the front wall and the back wall are defined as side walls. The front wall includes a frame and an acoustical cloth is attached on and covering the frame. The material of the back wall and the side walls can be wood, diamond, glass, quartz, ceramics or resin.

The insulated panel 3 is substantially parallel to the front wall of the casing 2, and is fastened on the side walls of the casing 2 with a binding agent (not shown) or a card slot 4. In one embodiment, the insulated panel 3 is held by the card slot 4 on the side walls of the casing 2. The surface of the insulated panel 3 exposed to the front wall of the casing 2 is defined as the front surface. A surface of the insulated panel 3 opposite to the front surface is defined as the back surface. The distance between the insulated panel 3 and the front wall is shorter than the distance between the insulated panel 3 and the back wall.

The acoustic cells 10 can be located on the front surface or the back surface of the insulated panel 3. In one embodiment, the acoustic cells 10 are located on the front surface of the insulated panel 3. Each of the acoustic cells 10 includes an acoustic element 14, a first electrode 142 and a second electrode 144. The acoustic element 14 is electrically connected to both the first electrode 142 and the second electrode 144. The first electrode 142 and the second electrode 144 are located on the two opposite sides of the acoustic element 14. The first electrode 142 and the second electrode 144 are spaced apart from each other and are electrically connected to the signal processing device 5 by a number of second conductive wires 149. The signal processing device 5 inputs electrical signals to the acoustic element 14 through first electrode 142 and the second electrode 144. The acoustic element 14 transforms the electrical signals into thermal energy via a thermal acoustic effect. The thermal energy heats up the surrounding medium, and thus creates sound. In the one embodiment, the acoustic element 14 is a carbon nanotube film structure.

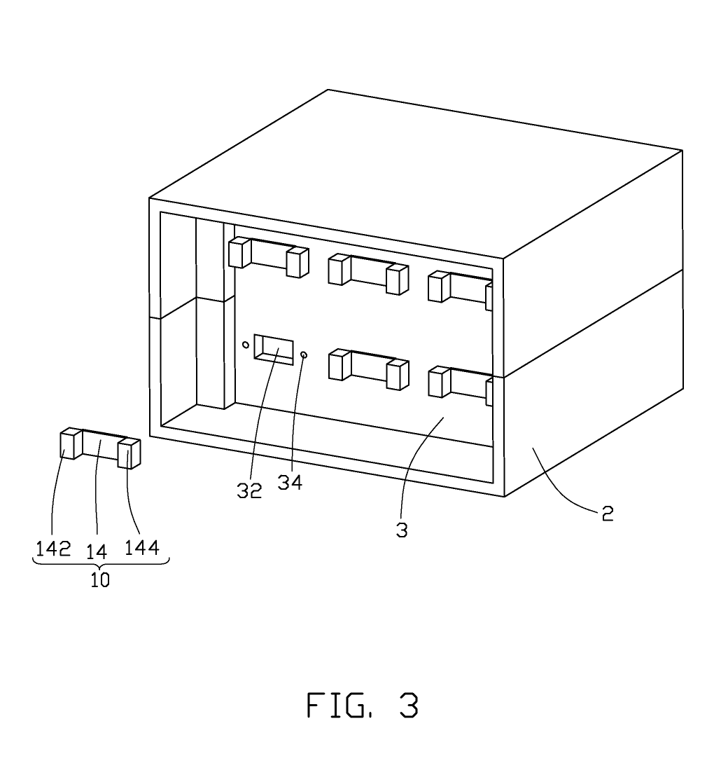

Referring to FIG. 3, the insulated panel 3 can define a number of first holes 32. If the acoustic cells 10 are located on the front surface of the insulated panel 3, the first hole 32 can be a through hole or a blind hole on the front surface of the insulated panel 3. If the acoustic cells 10 are located on the back surface of the insulated panel 3, the first hole 32 should be a through hole so the sound of the acoustic cells 10 will not be blocked off by the insulated panel 3. In one embodiment, the first hole 32 is a through hole. A shape of the first hole 32 is not limited. The shape of each of the first holes 32 can be the same as the shape of the acoustic element 14. The shape of each of the first holes 32 is substantially rectangular in one embodiment as is the acoustic element 14. The position of each of the first holes 32 corresponds to the position of one acoustic element 14. The first electrode 142 and the second electrode 144 are located on two opposite sides of each of the first holes 32. In one embodiment, the carbon nanotube film structure is located on the front surface of insulated panel 3 and covers each of the first holes 32. Reffering to FIG. 1., a portion of the acoustice element 14 covers the first hole 14. The first electrode 142 and the second electrode 144 are located on another portion of the acoustice element 14. The first electrode 142 and the second electrode 144 faste the acoustic element 14 on the insulated panel 3. At least a portion of the carbon nanotube film structure is suspended over the first hole 32 in one embodiment. The weight of the insulated panel 3 decreases because of the first holes 32.

A number of second holes 34 may be further defined in the insulated panel 3 and can be located at two sides of the first hole 32. Each second hole 34 is a through hole. Thus, the second conductive electrical wires can connect to the first electrode 142 or the second electrode 144 to connect to the signal processing device 5 through the second holes 34. Each second hole 34 corresponds to one first electrode 142 or one second electrode 144. By the arrangement of the second holes 34, the length of the second conductive wires 149 can be reduced, and the energy conversion efficiency of the acoustic cells 10 can be improved. The second conductive wires 149 can get through the second holes 34 and input the electrical signals from the signal processing device 5 to the acoustic cells 10.

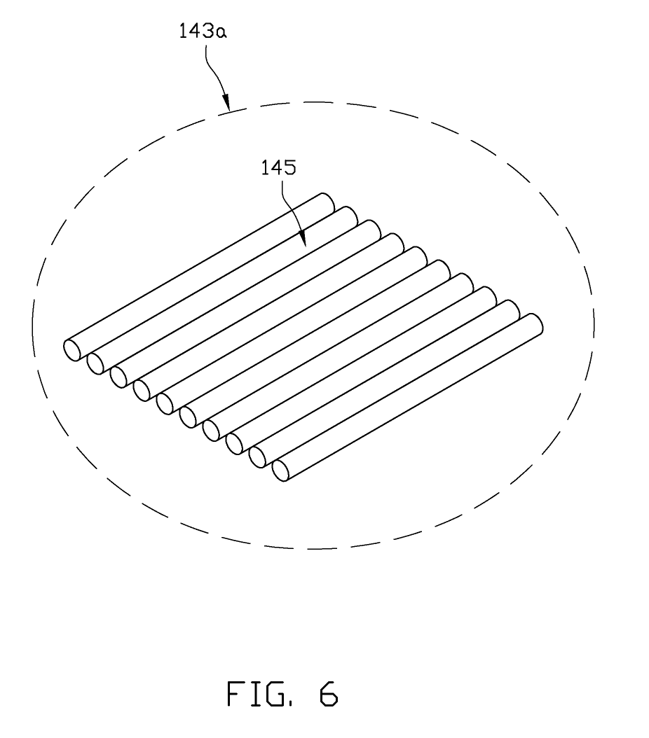

Referring to FIG. 6, in another embodiment, the first electrode 142 and the second electrode 144 are located on the front surface of the insulated panel 3. The acoustic element 14 is located on the surfaces of the first electrode 142 and the second electrode 144 away from the insulated panel. The acoustic element 14 is suspended by the first electrode 142 and the second electrode 144. No first hole should be defined.

The carbon nanotube film structure can be a freestanding structure. The term “freestanding”, includes, but is not limited to a structure that does not have to be formed on a surface of a substrate and/or can support its own weight. The carbon nanotube film structure includes at least one carbon nanotube film. If the carbon nanotube film structure includes a number of carbon nanotube films, the carbon nanotube films can be stacked. Two adjacent film-shaped carbon nanotube films are combined by van der Waals attractive force. An angle between aligned directions of the carbon nanotubes in two adjacent carbon nanotube films can range from about 0 degrees to about 90 degrees (0°≦α≦90°).

In one embodiment, the carbon nanotube film structure can be a drawn film. The drawn film can be drawn from a carbon nanotube array. Examples of the drawn carbon nanotube film are taught by U.S. Pat. No. 7,045,108 to Jiang et al., and WO 2007015710 to Zhang et al. The drawn carbon nanotube film includes a plurality of carbon nanotubes arranged substantially parallel to a surface of the drawn carbon nanotube film. A large number of the carbon nanotubes in the drawn carbon nanotube film can be oriented along a preferred orientation, meaning that a large number of the carbon nanotubes in the drawn carbon nanotube film are arranged substantially along the same direction. An end of one carbon nanotube is joined to another end of an adjacent carbon nanotube arranged substantially along the same direction by van der Waals attractive force. The drawn carbon nanotube film is capable of forming a freestanding structure. The successive carbon nanotubes joined end to end by van der Waals attractive force realizes the freestanding structure of the drawn carbon nanotube film.

Some variations can occur in the orientation of the carbon nanotubes in the drawn carbon nanotube film. Microscopically, the carbon nanotubes oriented substantially along the same direction may not be perfectly aligned in a straight line, and some curve portions may exist. It can be understood that a contact between some carbon nanotubes located substantially side by side and oriented along the same direction cannot be totally excluded.

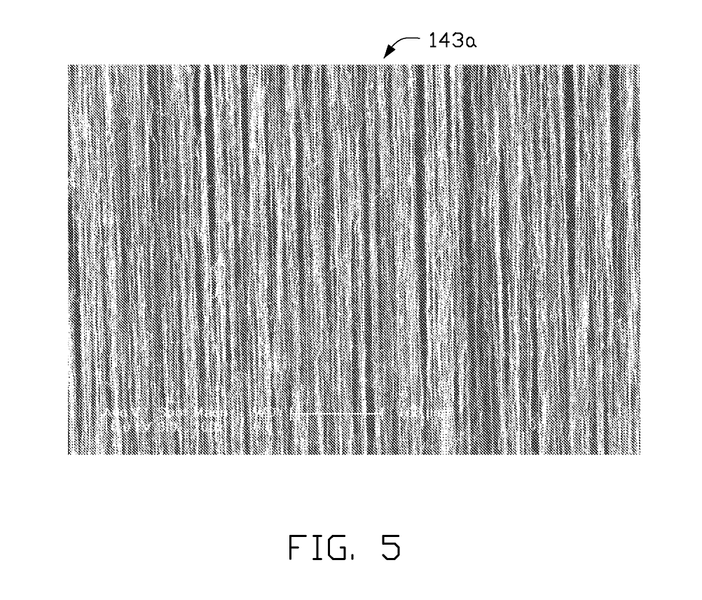

Please referring to the FIG. 5 and FIG. 6, the drawn carbon nanotube film can include a plurality of successively oriented carbon nanotube segments 143a joined end-to-end by van der Waals attractive force therebetween. Each carbon nanotube segment 143a includes a plurality of carbon nanotubes 145 substantially parallel to each other, and joined by van der Waals attractive force therebetween. The carbon nanotube segments 143a can vary in width, thickness, uniformity, and shape. A thickness of the drawn carbon nanotube film can range from about 0.5 nm to about 100 μm. Therefore, a thickness of the acoustic element 14 can range from about 0.5 nm to about 1 millimeter. A width of the drawn carbon nanotube film relates to the carbon nanotube array from which the drawn carbon nanotube film is drawn. When the carbon nanotube film structure consists of the drawn carbon nanotube film, and a thickness of the carbon nanotube film structure can be relatively small (e.g., smaller than 10 μm), the carbon nanotube film structure can have a good transparency, and the transmittance of the light can reach about 90%.

In one embodiment, the carbon nanotube film structure can be a flocculated carbon nanotube film. The flocculated carbon nanotube film can include a plurality of long, curved, disordered carbon nanotubes entangled with each other. A length of the carbon nanotubes can be larger than about 10 μm. Further, the flocculated carbon nanotube film can be isotropic. Adjacent carbon nanotubes are acted upon by van der Waals attractive force to obtain an entangled structure with micropores defined therein. The flocculated carbon nanotube film is very porous. The sizes of the micropores can be less than 10 μm. In one embodiment, the sizes of the micropores are in a range from about 1 nm to about 10 μm. Further, because the carbon nanotubes in the carbon nanotube film structure are entangled with each other, the carbon nanotube film structure employing the flocculated carbon nanotube film has excellent durability, and can be fashioned into desired shapes with a low risk to the integrity of the carbon nanotube film structure. The flocculated carbon nanotube film is freestanding because the carbon nanotubes are entangled and adhered together by van der Waals attractive force therebetween. The thickness of the flocculated carbon nanotube film can range from about 1 micrometer (μm) to about 1 millimeter (mm) In one embodiment, the thickness of the flocculated carbon nanotube film is about 100 μm. The flocculated carbon nanotube film can be folded into any shape and will not be damaged because the carbon nanotubes in the flocculated carbon nanotube film are entangled with each other.

In another embodiment, the carbon nanotube film includes a plurality of carbon nanotubes arranged along a preferred orientation. The carbon nanotubes are parallel with each other, have almost equal length and are combined side by side by van der Waals attractive force therebetween. A length of the carbon nanotubes can reach up to several millimeters. The length of the film can be equal to the length of the carbon nanotubes. Such that at least one carbon nanotube will span the entire length of the carbon nanotube film. The length of the carbon nanotube film is only limited by the length of the carbon nanotubes. In one embodiment, the length of the carbon nanotubes can range from about 1 millimeter to about 30 millimeters. The carbon nanotube films have a plurality of excellent properties, such as electricity conductive property and thermal conductive property.

The heat capacity per unit area of the acoustic element 14 can be less than 2×10⁻⁴ J/cm²·K. In one embodiment, the heat capacity per unit area of the acoustic element 14 is less than or equal to about 1.7×10⁻⁶ J/cm²·K. The length and width of the acoustic element 14 is not limited. In one embodiment, the length of the acoustic element 14 is about 3 centimeters, the width of the acoustic element 14 is about 3 centimeters, and the thickness of the acoustic element is about 50 nanometers.

The first electrode 142 and the second electrode 144 are made of conductive material. The shape of the first electrode 142 or the second electrode 144 is not limited and can be lamellar, rod, wire, and block among other shapes. A material of the first electrode 142 or the second electrode 144 can be metals, conductive adhesives, carbon nanotubes, and indium tin oxides among other materials. In one embodiment, the first electrode 142 and the second electrode 144 are rod-shaped metal electrodes. The acoustic element 14 is electrically connected to the first electrode 142 and the second electrode 144. The first electrode 142 and the second electrode 144 can provide structural support for the acoustic element 14. If the acoustic element 14 is composed of a film-shaped carbon nanotube structure, the first electrode 142 and the second electrode 144 can be located on the two sides of the film-shaped carbon nanotube structure. The portion of the carbon nanotube film structure between the first electrode 142 and the second electrode 144 to produce sound, heats the air surrounding the carbon nanotube film structure. In use, when electrical signals with variations are input applied to the film-shaped carbon nanotube structure of the acoustic element 14. Heating is produced in the film-shaped carbon nanotube structure according to the variations of the electrical signal and/or signal strength. Temperature waves, which are propagated into air. The temperature waves produce pressure waves in the air, resulting in sound generation. Because the carbon nanotube film structures have large specific surface area, the acoustic element 14 can be adhered directly to the first electrode 142 and the second electrode 144. This will result in a good electrical connect between the acoustic element 14 and the first electrode 142 and the second electrode 144.

In other embodiments, a conductive adhesive layer (not shown) can be further provided between the first electrode 142 or the second electrode 144 and the acoustic element 14. The conductive adhesive layer can be applied to the surface of the acoustic element 14. The conductive adhesive layer can be used to provide electrical connect and more adhesion between the electrodes 142 or 144 and the acoustic element 14. In one embodiment, the conductive adhesive layer is a layer of silver paste.

The signal processing device 5 is electrically connected to the signal source 6 through the first conducting wire 7. The signal processing device 5 copies and delays the electrical signals received from the signal source 6 to form a number of delayed ectypal signals. The signal processing device 5 sends the delayed ectypal signals to the corresponding acoustic cells 10. The electrical signals are delayed in accordance with the position of one acoustic cell 10 in the array of the acoustic cells 10 and a given direction to control the direction of the sounds produced by the acoustic cells 10. The sounds produced by the array of the acoustic cells 10 form two sound beams. The signal processing device 5 calculates the position of a room where the sound beams will be reflected. Walls or ceilings of the room reflect the sound beams to form at least one reflected sound beam. The sound beams of the acoustic cells 10 can reach the listener directly or after being reflected. The sound beams reach the listener from the front, two sides, and the back of the listener at the same time. Therefore, the listener can hear simulated surrounding sounds. The number of sound beams of the digital sound projector 1 can be three or five. The digital sound projector 1 can be located on the wall of the room, or assembled with the furniture.

In one embodiment, the sound of the acoustic cell 10 spreads along a direction substantially perpendicular to a surface of the carbon nanotube film structure. Because the directivity of sounds produced by the carbon nanotube film structure is strong, the directionality of sounds of the acoustic cell 10 is clear. Thus, the directivity of sound beams of the digital sound projector 1 is improved accordingly.

The digital sound projector 1 provided by the present disclosure has the following benefits: (1) compared to the conventional speaker which includes diaphragm, magnetic circuit, bobbin and damper, the structure of the acoustic cell 14 is simple because the acoustic element 14 of the acoustic cell 14 is composed of the carbon nanotube film structure. Therefore, the structure of the digital sound projector 1 is simple; (2) the acoustic cell 10 is composed of two electrodes and a carbon nanotube film structure, therefore, the thickness of the digital sound projector 1 can be smaller, and the weight of the digital sound projector 1 can decrease.

Finally, it is to be understood that the above-described embodiments are intended to illustrate rather than limit the disclosure. Variations may be made to the embodiments without departing from the spirit of the disclosure as claimed. Elements associated with any of the above embodiments are envisioned to be associated with any other embodiments. The above-described embodiments illustrate the scope of the disclosure but do not restrict the scope of the disclosure.

What is claimed is:

1. A digital sound projector comprising:
an insulated panel;
a plurality of acoustic cells located on a surface of the insulated panel and spaced apart from each other, each of the plurality of acoustic cells comprising:
an acoustic element comprising a carbon nanotube film structure;
a first electrode; and
a second electrode, wherein the first electrode and the second electrode are spaced apart from each other and electrically connected to the acoustic element; and
a signal processing device configured for providing a plurality of delayed electrical signals to the plurality of acoustic cells.

2. The digital sound projector of claim 1, wherein the plurality of acoustic cells is arranged in an array.

3. The digital sound projector of claim 1, wherein the carbon nanotube film structure is a free-standing structure.

4. The digital sound projector of claim 1, wherein a thickness of the carbon nanotube film structure ranges from about 0.5 nanometers to about 100 micrometers.

5. The digital sound projector of claim 1, wherein a heat capacity per unit area of the carbon nanotube film structure is less than 2×10⁻⁴ J/cm²·K.

6. The digital sound projector of claim 5, wherein the heat capacity per unit area of the carbon nanotube film structure is less than or equal to 1.7×10⁻⁶ J/cm²·K.

7. The digital sound projector of claim 1, wherein the carbon nanotube film structure comprises a plurality of carbon nanotubes arranged along the same direction.

8. The digital sound projector of claim 7, wherein the plurality of carbon nanotubes is joined end by end by van der Waals attractive force.

9. The digital sound projector of claim 1, wherein the carbon nanotube film structure comprises a plurality of carbon nanotubes entangled with each other.

10. The digital sound projector of claim 1, wherein the carbon nanotube film structure comprises a plurality of carbon nanotubes, and the plurality of carbon nanotubes are of substantially equal length and are combined side by side by van der Waals attractive force therebetween.

11. The digital sound projector of claim 1, wherein the insulated panel defines a plurality of first holes, and the carbon nanotube film structure is located on the surface of the insulated panel and covers one of the plurality of first holes.

12. The digital sound projector of claim 11, wherein the plurality of first holes are blind holes or through holes.

13. The digital sound projector of claim 1, wherein the first electrode and the second electrode are electrically connected to the signal processing device.

14. The digital sound projector of claim 1, further comprising a casing configured for accommodating the insulated panel, the plurality of acoustic cells, and the signal processing device therein; wherein the insulated panel defines a plurality of second holes, wherein each of the plurality of second holes corresponds to the first electrode or the second electrode.

15. The digital sound projector of claim 14, further comprising a plurality of second wires, and the plurality of second wires runs through the plurality of second holes and electrically connects the first electrode and the second electrode to the signal processing device.

16. The digital sound projector of claim 1, wherein the first electrode and the second electrode are located on the surface of the insulated panel, and the acoustic element is located on surfaces of the first electrode and the second electrode away from the insulated panel and the acoustic element is suspended from the insulated panel by the first electrode and the second electrode.

17. The digital sound projector of claim 14, wherein the casing has a front wall which allows sounds produced by the plurality of acoustic cells to pass therethrough.

18. The digital sound projector of claim 17, wherein the front wall comprises a frame and a cloth attached on and covering the frame.

19. A digital sound projector comprising:
an insulated panel;
a plurality of acoustic cells located on a surface of the insulated panel and spaced apart from each other, each of the plurality of acoustic cells comprising:
an acoustic element consisting of a carbon nanotube film structure;
a first electrode located on a surface of the insulated panel; and
a second electrode located on the surface of the insulated panel, wherein the first electrode and the second electrode are spaced apart from each other and electrically connected to the acoustic element, the acoustic element is located on the first electrode and the second electrode away from the insulated panel, the acoustic element is suspended by the first electrode and the second electrode; and
a signal processing device configured for providing a plurality of delayed electrical signals to the plurality of acoustic cells.

20. A digital sound projector comprising:
an insulated panel defining a plurality of holes;
a plurality of acoustic cells located on a surface of the insulated panel and spaced apart from each other, each of the plurality of acoustic cells comprising:
an acoustic element consisting of a carbon nanotube film structure located on the surface of the insulated panel and suspended through one of the plurality of holes;
a first electrode located on a surface of the carbon nanotube film structure; and
a second electrode located on the surface of the carbon nanotube film structure, the first electrode and the second electrode are spaced apart from each other and electrically connected to the acoustic element; and
a signal processing device configured for providing a plurality of delayed electrical signals to the plurality of acoustic cells.
